(19) United States
(12) Patent Application Publication
(10) Pub. No.: US 2008/0208963 A1
(43) Pub. Date: Aug. 28, 2008

(54) Online File Sharing

(76) Inventors: Aviv Eyal, New York, NY (US); Josh Felser, Mill Valley, CA (US)

Correspondence Address: MAYER & WILLIAMS PC, 251 NORTH AVE. WEST, 2ND FLOOR, WESTFIELD, NJ, 07090, US

(21) Appl. No.: 11/874,574

(22) Filed: Oct. 18, 2007

Related U.S. Application Data
(60) Provisional application No. 60/853,294, filed on Oct. 19, 2006.

(51) Int. Cl. G06F 15/16

(52) U.S. Cl. 709/203

(57) ABSTRACT

Systems and methods are disclosed involving sharing data files amongst a group in a networked system. In a first embodied system and method, a user uploads a video file to a file sharing server over a network and the server makes the file available for access by a group of users. In a second embodied system and method, the user shares a file with the group of users using a peer-to-peer model. The systems and methods may be operated in conjunction with a separate social networking system, in which case certain features may operate jointly, such as user authentication. Even if the file sharing server or social networking system are not involved in the actual file transfer, each may be used to facilitate group generation, group information storage, file preview storage, file availability notification, messaging, user verification, and other features. The group with whom a file is shared may be defined by the user who uploads the file, may be automatically generated, such as by analysis of the user's settings in the social networking system, or may be generated by the user or file sharing server sending invitations to a chosen or defined set of users.

### CROSS-REFERENCE TO RELATED APPLICATIONS

The application claims the benefit of U.S. Provisional Patent Application Ser. No. 60/853,294, filed Oct. 19, 2006, entitled “Online File Sharing,” the entirety of which is incorporated by reference herein for all purposes, and is assigned to the assignee of the present invention.

### BACKGROUND

The online sharing of media files is ubiquitous on networks, especially the Internet. However, controlling access to these media files is challenging. Access may be undesiredly attained by those to whom the files should not be accessed, and access may be unavailable to those to whom the provider wishes to share the file.

In addition, many network users avail themselves of the features offered by online social networking systems (SNS). These systems provide a convenient way to manage lists of friends and other associates, and to share information with the same.

### SUMMARY

The described systems disclose systems and methods for controlling access to shared online media files, and which further allow files to be distributed to groups of users as desired by a providing user. The systems and methods can desiredly take advantage of user preferences already defined in SNSs, as well as much of the user interface provided therein.

Systems and methods are disclosed that involve sharing data files amongst a group in a networked system. In a first embodied system and method, a user uploads a video file to a file sharing server, which is part of a file sharing system (FSS), over a network and the FSS makes the file available for access by a group of users. In a second embodied system and corresponding method, the user shares a file with the group of users using a peer-to-peer model. The systems and methods may be operated in conjunction with a separate social networking system, in which case certain features may operate jointly, such as user authentication. Even if the FSS or SNS are not involved in the actual file transfer, each may be used to facilitate group generation, group information storage, file preview storage, file availability notification, messaging, user identify verification, and other features.

The group with whom a file is shared may be defined by the user who uploads the file, may be automatically generated, such as by analysis of the user's settings in the SNS, or may be generated by the user or FSS or both, and may involve sending invitations to a chosen or defined set of users.

In one aspect, the invention is directed towards a method for sharing files, comprising: storing a file in a share folder on a user computer, or uploading a file to a file sharing server; defining a share group; and making the file accessible to the share group. The invention is also directed towards a computer readable medium containing instructions for causing a computer to implement this method.

Implementations of the method may include one or more of the following. The defining a share group may further comprises storing information about the share group on the file sharing server. The storing or uploading may include executing instructions on a user system, the instructions corresponding to file sharing software. The file may be uploaded to a file sharing server, and the file may be sent to each member of the share group. The file may be stored on a user computer, and the file may be sent from the user computer to each member of the share group. The method may further include sending a notification about the file to each member of the share group, such as an email or a text message. The file may be a media file, such as an audio file, a video file, or a text file. The defining a share group may further comprise analyzing user information in a social networking system. The defining a share group may also further comprise accepting a user input of contact information of at least one other user, where the accepting is in the context of a social networking system. The defining a share group may also further comprise sending invitations to join the share group to at least one user system, the user system defined by: user input, preferences defined in a social networking system, or preferences defined by another application, such as a personal information manager, which may be disposed on a user computer or online. The defining a share group may also further comprise sending an invitation to join the share group to at least one user system, the user system defined by preferences defined in a social networking system, wherein the invitations are acceptable by: clicking an embedded link, visiting a site on the social networking system, or visiting a site on the file sharing system, and further comprising authenticating share group members who accept the invitations. In this case, the authenticating may include accepting user information corresponding to the social networking system, and may further include transmitting an identification code, but not the user information, to the file sharing system.

In yet another aspect, the invention is directed towards a method for sharing files, including: storing a file in a share folder on a user computer, or uploading a file to a file sharing server; defining a share group within a social networking system; and making the file accessible to the share group within the social networking system. The invention is also directed towards a computer readable medium containing instructions for causing a computer to implement this method.

In yet a further aspect, the invention is directed towards a method for sharing files, comprising: storing a file in a share folder on a user computer, or uploading a file to a file sharing server; defining a share group within a social networking system, wherein the defining a share group further includes: analyzing user information within the social networking system, sending an invitation to join the share group to at least one user system, the user system defined by the user information; wherein the invitations are acceptable by: clicking an embedded link, visiting a site on the social networking system, or visiting a site on the file sharing system, and further comprising authenticating share group members who accept the invitations; making the file accessible to the share group within the social networking system; sending a notification about the file to each member of the share group. The invention is also directed towards a computer readable medium containing instructions for causing a computer to implement this method.

Advantages of the invention may include one or more of the following. The disclosed systems and methods can allow a defined group of users to access an online file, thereby prohibiting access to others and yet ensuring that all users within the group are notified about the file. The systems and methods can take advantage of certain functionality of SNSs, and can use the authentication or verification capabilities thereof, limiting the amount of personal user information disclosed to the file sharing system. Other advantages will be apparent from the description that follows, including the drawings and claims.

### BRIEF DESCRIPTION OF THE DRAWINGS

FIG. 1 illustrates a schematic diagram of a system according to a first embodiment of the invention, in which a user uploads a shared file to an FSS.

FIG. 2 illustrates a schematic diagram of a system according to a second embodiment of the invention, in which a user shares a file in a peer-to-peer fashion.

FIG. 3 illustrates a flowchart of a method according to the first embodiment of the invention.

FIG. 4 illustrates a flowchart of a method according to the second embodiment of the invention.

FIG. 5 illustrates a schematic diagram of a system according to a third embodiment of the invention, in which certain aspects of an SNS are employed.

FIG. 6 illustrates a flowchart of a method according to the third embodiment of the invention.

FIG. 7 illustrates a flowchart of a method that may apply to any embodiment of the invention.

FIG. 8 illustrates a flowchart of another method that may apply to any embodiment of the invention.

FIG. 9 illustrates a flowchart of a method that may be employed in the third embodiment of the invention.

FIG. 10 illustrates a flowchart of a method that may apply to any embodiment of the invention.

### DETAILED DESCRIPTION

The following terms, defined here, are used throughout the specification.

“Uploading” a file refers to the act of transferring a file from a user's computer to either a server or to at least one other user's computer (in a peer-to-peer network).

A “file sharing server” or FS server refers to a dedicated server to which files are transferred. Typically these files will then be shared with other users. The FS server may also be employed to coordinate and organize the transfer of files in a peer-to-peer network, but without ever actually hosting the shared file itself. A file sharing system, FSS, or “FS system” refers to an FS server and accompanying methods, software, and subsystems.

A “share group” refers to a defined group of users that are a target audience of a shared file. A share group is typically defined by a user, and corresponds to that user's group of friends or other defined cohort. A user may have more than one share group, e.g., a share group may be defined for each separate interest of the use and the user can select which group to use for any particular shared file. A share group may also be constructed automatically, such as via an analysis of user settings in a separate application, such as an SNS. An application running in the FS system may perform such an analysis. A share group may be created on a user system using, e.g., contacts information such as is stored in Outlook®, and via invitations being distributed as described in more detail below.

A “social networking system” or SNS refers to an online community of users usually connected via the Internet. The users can typically interact with each other via messaging and email, and can express preferences to each other about various interests and groups. Exemplary SNSs include YouTube®, MySpace®, and Grouper ®.

Systems and methods according to embodiments of the invention can allow users to share data files (the “shared file”), such as audio or video files, by facilitating the transfer from one user's computer to another user's computer.

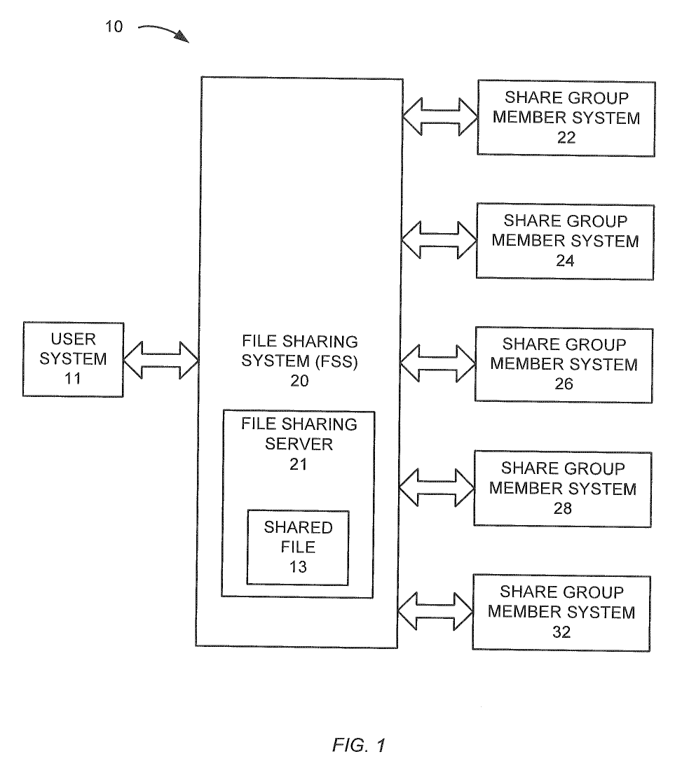

In a first embodiment, a user uploads a file to an FS server corresponding to an FSS, and then a second user downloads the same file from the FS server. In more detail, and referring to FIG. 1, a system 10 includes a user system 11 that communicates with an FSS 20 such as over a network like the Internet. In a first embodiment, the user system uploads the file to be shared to the FSS, and in FIG. 1 this is depicted as a shared file 13. Potential recipients of the shared file 13 are termed share group members, and in FIG. 1 these are depicted as share group member systems 22, 24, 26, 28, and 32. Via methods disclosed in more detail below, the first user can define who can access files shared on the FSS by creating or defining the share group. The user may also establish multiple groups and select which group to use for any particular shared file.

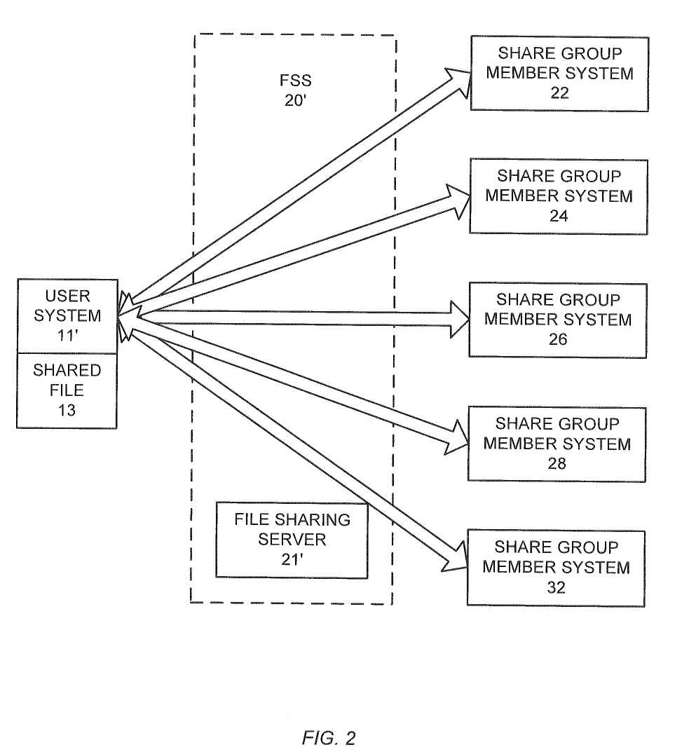

In a second embodiment, users share files directly (or “peer-to-peer”) by making the files available for network transfer on the user computer and by transferring a shared file from the first user's computer to a second user's computer. In this case, the server acts to facilitate the transfer, such as to help the users locate one another and to distribute group information. Optionally, the server acts as a proxy server that enables network communications between the users' computers. In more detail, and referring to FIG. 2, a user system 11 communicates shared file 13 directly to share group members 22-32 in a peer-to-peer configuration, employing FSS 20′ including FS server 21′ to accomplish ancillary tasks such as user and share group member location, authentication or verification, and other such tasks.

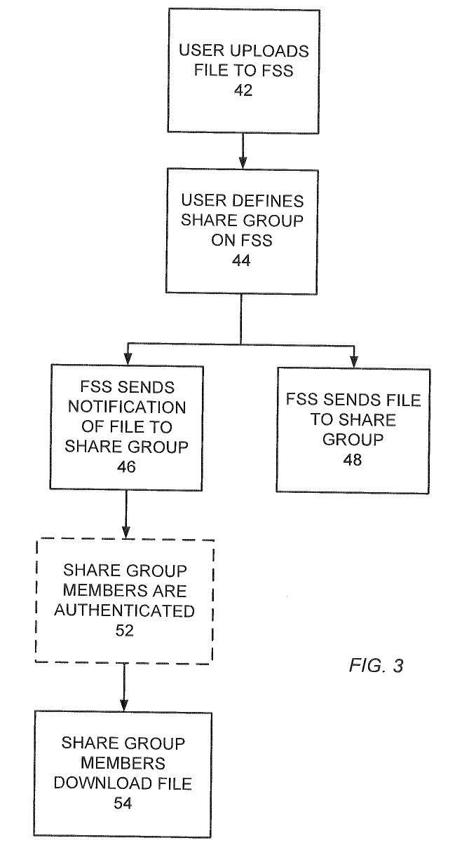

FIG. 3 is a flowchart that illustrates a method of use for the first embodiment. A user uploads the shared file to the FSS (step 42), and the same is stored on the FS server. The shared file is typically some type of media file such as an audio or video file, but may also be a text file or any other type of file. A share group is defined on the FSS (step 44). The share group may have already been defined as part of the user's prior interactions with the FSS, or may be alternately defined later, after the shared file upload. A different share group may be defined for each shared file if desired. The method of creating the share group is described below, but at this point it is noted that the share group may simply be creating by the user providing a list of contacts to the FSS.

In one version of this first embodiment, the FSS sends a notification of the shared file to each member of the share group (step 46). This notification may be, e.g., an email, a text message, or any other sort of communication, and may contain various information about the file. For example, the notification may simply contain information about the existence of the shared file and an appropriate URL to visit to download or view the same or a preview of the same. The notification may also contain a preview of the shared file. The notification may contain a clickable link which when clicked starts a preview or which initiates a file transfer for viewing or download, or which when clicked opens a URL where the share group members may preview the file or download the same. For any of these actions, the identities of the share group members may be optionally authenticated or verified (step 52) via input of a user ID, password, or other identify information. After authentication, the shared file may be downloaded (step 54).

In an alternative version of this embodiment, the FSS may send a copy of the file to each share group member (step 48).

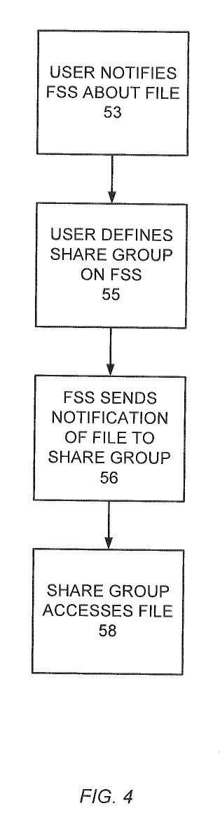

FIG. 4 is a flowchart that illustrates a method of use for the second embodiment. A user notifies the FSS about the shared file (step 53), including such information as the file provider identity, the URL where the shared file may be found, and so on. The user then defines or employs a share group on the FSS in a similar manner as that indicated above in connection with step 44 (step 55). The FSS sends a notification of the shared file to the members of the share group (step 56). Finally, the members of the share group access the shared file directly on or from the user system (step 58). Alternatively, the user system, or file sharing software located on the user system, described below, may send the shared file directly to the share group.

Implementations of this embodiment may include several variations. For example, while the shared file itself is not stored on the server, a preview could be stored. The shared file may be transferred over a network between the users' computers, or indirectly by using another computer that acts as a proxy between the two computers that are involved in the transfer. In some cases, the FSS stores information such as: an indication that the shared file is available for sharing, the name of the share group or groups for the file, where the shared file is located, e.g., a URL, and so on. The user can edit the share group list, such as by adding or deleting members, using an appropriate interface provided by the file sharing software described below. The FSS may send a notification or invitation to each of the members of the share group, or to a set of contacts or other listings relevant to the user, to indicate that the shared file is available for access. In some cases the FSS stores information about the group such as the group member credentials and the network location of group member systems that enables software executing on the group member systems to share files privately and securely between the systems over the network. The shared file is generally prohibited from being accessed by users not in the share group.

The various user system interactions, e.g., with the FSS, with share group members, and with other social communities as will be described, may be accomplished with appropriate file sharing software. The file sharing software may be downloaded by the user, loaded onto the user system via removable media, or may be automatically downloaded onto the user system the first time the user system interacts with the FSS. The file sharing software guides the user through the sharing process, e.g., selecting the file to share, setting the conditions for sharing, and so on. Such file sharing software may include various functionality including: log-in functionality, file transfer functionality, authentication or verification functionality, networking functionality so that the user system can interact with and transfer files with the FSS, with a proxy server, or with an optional social networking community.

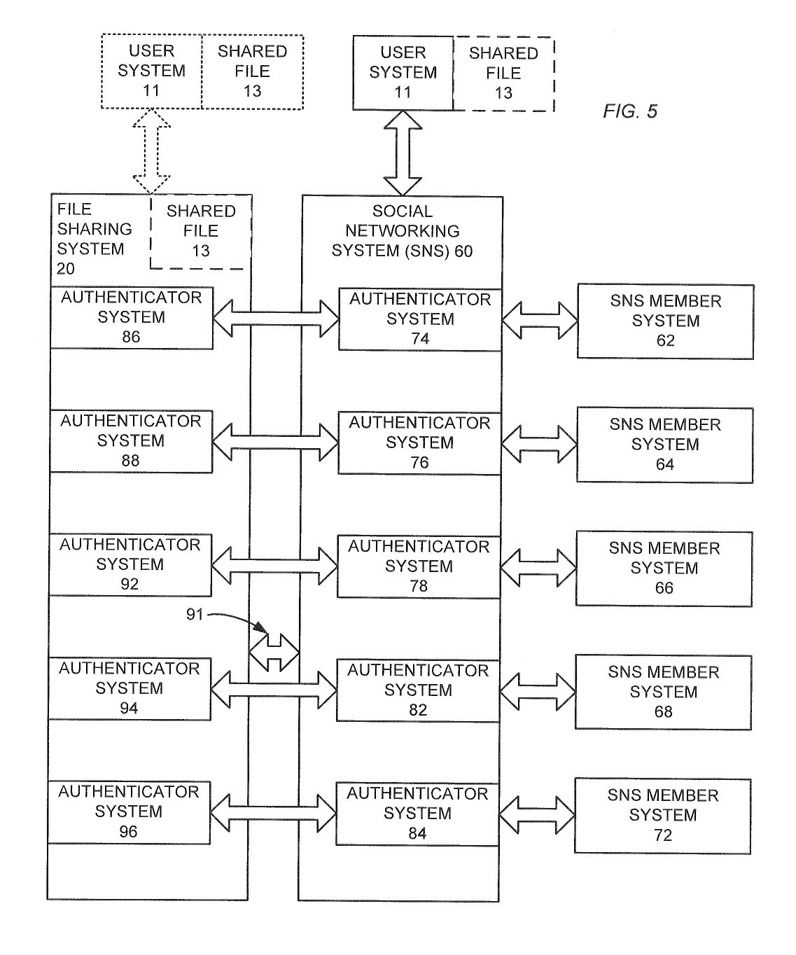

FIG. 5 illustrates a schematic of a system according to a third embodiment of the invention in which a user system 11 shares a shared file 13 with other users via employment of the FSS 20 and a social networking system (SNS) 60, these latter two communicating via a link 91.

An SNS is a type of online service that allows users, e.g., SNS member systems 62, 64, 66, 68, and 72, to publish information about themselves, e.g., text, audio, or video, to a server and make that information available to other users. The users can also interact with one another based on the information provided through the SNS. The SNS tracks the relationships among users and so defines how different users relate to one another. For example, the service has a list of friends for a user that represent users defined by the user as friends.

In one implementation of the third embodiment, the file sharing software is configured to allow a user of the SNS, indicated by the solid-line user system 11, to share files using the FSS through the SNS. This interoperability allows a user to access the tools of the FSS in the context of the SNS, e.g., via a link within a website associated with the SNS. In this way, a user can share a file with the user's friends or other groups or contacts defined by the SNS. A user system 11 that is not part of the SNS 60, e.g., one that is only affiliated with FSS 20, may also be the source of shared files (see the dotted-line user system 11).

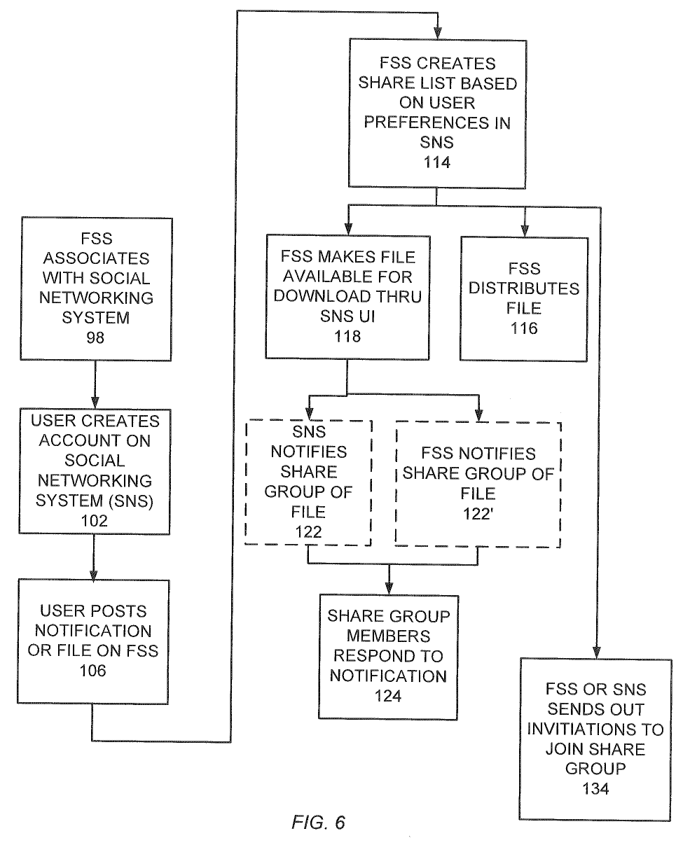

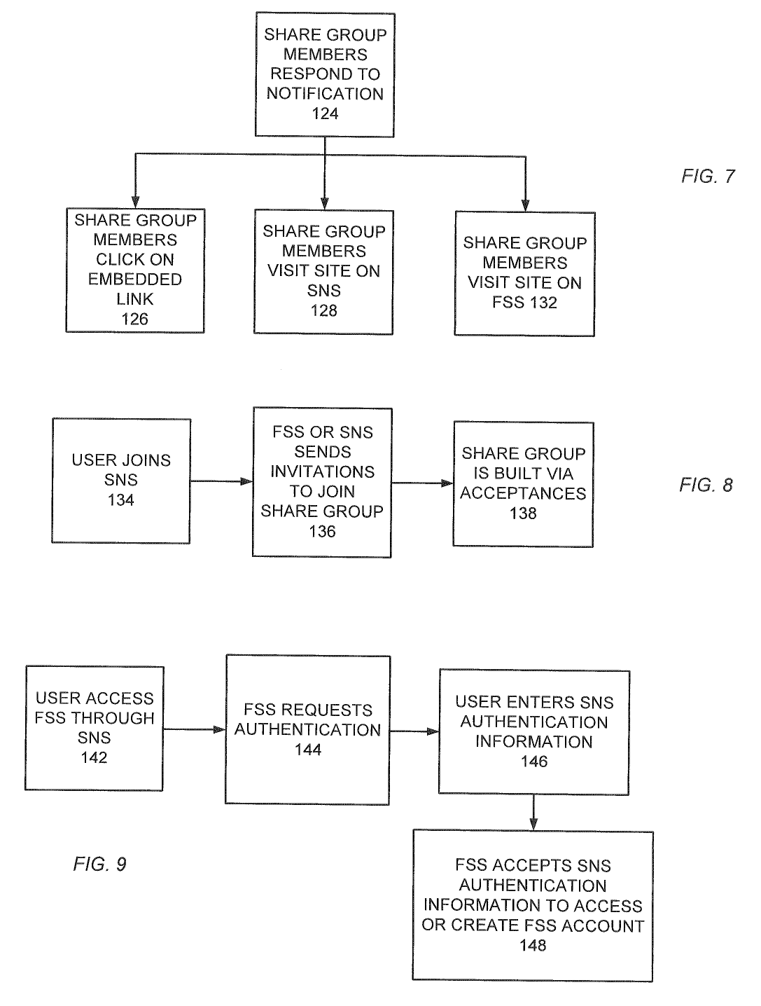

In more detail, and referring to FIG. 6, an FSS associates with an SNS and communicates with the same via link 91 (step 98). A user creates an account on the SNS (step 102). When a user desires to share a file with other users, the user posts the file or a notification of the file on the FSS (step 106). Prior to, during, or following step 106, the FSS creates a share group based on user preferences as delineated in the SNS profile (step 114). The FSS then distributes the file (step 116), or otherwise makes the file available for download through the user interface of the SNS (step 118). In making the file available for download, the SNS may notify the share group of the file (step 122), or the FSS may notify the share group of the file (step 122′). In any case, following notification, the share group members may respond to the notification (see FIG. 7) as is described below. In another implementation, the FSS uses the SNS settings or preferences to create a contact list or potential share group list, to which invitations to join the file share group are distributed (step 134).

Implementations of this embodiment may include the following. A user employing user system 11 may define a list of friends within the context of the SNS. In FIG. 5, this list is shown to include SNS member systems 62, 64, 66, 68, and 72. The user may access the FSS through a link at the SNS, and this link may click through to a website associated with the SNS. In this case, the website may operate as a user interface for the SNS. This site may include numerous other features for social networking, and may further include a clickable link to the FSS.

The file sharing software can reside on the user's computer, the server associated with the SNS, or the FS server. The file sharing software may retrieve a list of contacts' or friends' identifiers such as nicknames, email addresses, URLs for SNS member home pages, or user IDs from the SNS, and may use the same to build a share group. This building of a share group may occur automatically or may occur with the assistance of various user input. For example, the file sharing software may be the subsystem that analyzes the user's settings at the SNS and builds one or more FSS share groups according to the groupings at the SNS. Alternatively, the file sharing software may simply accumulate a series of contact names for the user to group as they wish, such as from a personal information manager. In any case, the share group may include contact information such as noted above, e.g., email addresses, nicknames, SNS user IDs, or URLs for SNS member home pages, and the FSS may store the share group contact information along with the shared file 13.

As noted in a prior embodiment, the FSS may send a notification or invitation to share group members to indicate that a shared file is available for access. In embodiments including SNS 60, the FSS may send a request for notification to the SNS and then the SNS may send out the notifications. The notification can be a direct email to the users or a notification through an internal messaging system of the SNS, such as via an instant message, text message, or email. Referring to FIG. 7, the recipients can then respond to the notification (step 124) and access the shared file through the notification, e.g., via an embedded link (step 126), through the SNS (step 128), e.g, a link on the recipient's page or on the sharer's page, or through the FSS (step 132), e.g., as a member of the defined share group.

Using these techniques, a user can share one or more files with the user's friends while staying in the context of the SNS but while taking advantage of the file sharing tools afforded by the FSS. Similarly, a user can access a file shared by another user through the SNS while relatively transparently employing the FSS as the actual mechanism. This interaction also allows the two online services to benefit from their respective expertise while providing enhanced services to their users.

In yet a further implementation, a user can create a share group through the SNS independently of sharing a file. Referring to FIG. 8, a user may join the SNS (step 134). The user can then invite friends, contacts, or other users to join the share group through the file sharing software. The FSS sends invitations (step 136) and records the acceptances of the invitations in order to build the group (step 138). Alternatively, the SNS sends out the notifications and records acceptances. Of course, the SNS or FSS could send out notifications while the other records acceptances. In any case, the members of the share group can later share files with each other, selecting that share group or groups when sharing a file through the file sharing software.

Users may also browse files shared by other users; however, generally only group members may browse a listing of files shared by any other group member.

The FSS may authenticate potential share group SNS members using their SNS credentials such as user name and password before allowing them to join the share group or to share a file. For example, and referring back to FIG. 5, SNS member systems 62-72 may initially become members of a share group associated with user system 11 by authenticating their identity using authenticator subsystems 74-84 of the SNS 60. These are shown as separate entities but may of course be the same subsystem and submethod. The SNS authenticator subsystems 74-84 may then communicate with FSS authenticator subsystems 86-96, respectively. As with the SNS subsystems, FSS authenticator subsystems 86-96 may comprise a single subsystem and submethod. In FIG. 5, the authenticator subsystems of the SNS and those of the FSS are shown communicating information from one to another directly; however, it should be clear that the actual data flow occurs via the link 91 from the SNS 60 to the FSS 20 and vice-versa.

In a method corresponding to FIG. 5, and referring in particular to FIG. 9, a user may access the FSS through an SNS (step 142). The FSS requests authentication or verification (step 144) from the user. The user enters their SNS authentication information (step 146). In this instance, the user may or may not have corresponding FSS authentication or verification information. Then the FSS accepts the SNS authentication information in order to access the FSS account, or to create a new account on the FSS (step 148).

Implementations of this system and method may include several variations. As described, authentication and messaging for users of the SNS are essentially controlled by the SNS server. When a user first accesses the file sharing software, e.g., through a link on the SNS user interface, the user is prompted for authentication information. The user can supply the user's SNS information rather than creating new FSS information. When the FSS creates a new account for that user, the FSS references the SNS and relies on the SNS for authentication. When a user joins a group, e.g., by accepting an invitation to join a group, that user can also download the file sharing software and be authenticated using the SNS information. Similarly, the contact information, e.g., email address and password, for a user added to a group can be controlled by the SNS and not shared with the FSS. In this case, to communicate with an SNS user, the FSS sends the request to the SNS that identifies the user using an identifier or a token, which in turns sends the communication to the indicated user. The chain works similarly in reverse as well, such as for replies from that user to the FSS.

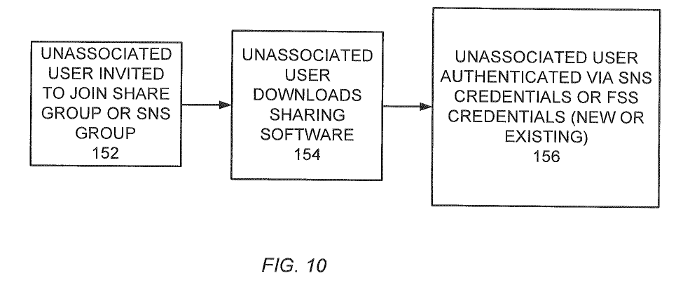

In a further embodiment, and referring to FIG. 10, a user unassociated with either the FSS or any SNS may be invited to join a share group or an SNS group, such as a friends group (step 152). The unassociated user may then download the file sharing software or otherwise install the file sharing software (step 154). The unassociated user may then be given or may create a user ID and password for the FSS or SNS. Then the unassociated user is authenticated via their new FSS or SNS credentials (step 156). Following this authentication step, the user can share files or download shared files, either within the context of the FSS or the SNS or both.

One implementation of the invention includes one or more programmable processors and corresponding computer system components to store and execute computer instructions, such as to provide the SNS, FSS, the sharing software, and the shared files. Users can access the systems through client computers with access to a network, such as the Internet.

Additional variations and implementations are also possible. For example, the shared files can be any type of data files—audio, video, text, data, and so on. The network transfer of shared files between users can be encrypted or clear. The sharing software can be stored on the servers but downloaded automatically to users' systems for execution. The FSS can support multiple levels of access for a shared file, e.g., a preview version of a file can be made available to a large group or publicly and the full version only made available to a subset. While the term “computer” has been used, this term is intended to encompass any computing machine, including desktop computers, laptop computers, handheld computers, tablet computers, smart phones, personal digital assistants, and any other device to or from which a file may be transferred. The invention may be implemented in any programming language. Various other examples could also be formulated given this teaching.

According to the present invention, as fully described above, systems and methods are provided for controlling access to shared online media files, and allow the file to be distributed to all users as desired by a providing user. The systems and methods can desiredly take advantage of user preferences already defined in social networking systems, as well as much of the user interface provided therein.

While the invention has been described in the context of online communities, it should be clear to one of ordinary skill in the art, given this teaching, that the invention is much broader than the embodiments shown. In particular, the invention may be implemented in the context of any networked group of persons.

Accordingly the description represents some but not all representations, and therefore the scope of the invention is limited only by the claims appended hereto.

1. A method for sharing files, comprising:
a. storing a file in a share folder on a user computer, or uploading a file to a file sharing server;
b. defining a share group; and
c. making the file accessible to the share group.

2. The method of claim 1, wherein the defining a share group further comprises storing information about the share group on the file sharing server.

3. The method of claim 1, wherein the storing or uploading includes executing instructions on a user system, the instructions corresponding to file sharing software.

4. The method of claim 1, wherein the file is uploaded to a file sharing server, further comprising sending the file to each member of the share group.

5. The method of claim 1, wherein the file is stored on a user computer, further comprising sending the file from the user computer to each member of the share group.

6. The method of claim 1, further comprising sending a notification about the file to each member of the share group.

7. The method of claim 6, wherein the notification is an email or a text message.

8. The method of claim 1, wherein the file is a media file.

9. The method of claim 8, wherein the file is an audio file, a video file, or a text file.

10. The method of claim 1, wherein the defining a share group further comprises analyzing user information in a social networking system.

11. The method of claim 1, wherein the defining a share group further comprises accepting a user input of contact information of at least one other user.

12. The method of claim 11, wherein the accepting is in the context of a social networking system.

13. The method of claim 1, wherein the defining a share group further comprises sending invitations to join the share group to at least one user system, the user system defined by: user input, preferences defined in a social networking system, or preferences defined by another application.

14. The method of claim 13, wherein the another application is a personal information manager.

15. The method of claim 14, wherein the another application is an online personal information manager.

16. The method of claim 13, wherein the defining a share group further comprises sending an invitation to join the share group to at least one user system, the user system defined by preferences defined in a social networking system, wherein the invitations are acceptable by: clicking an embedded link, visiting a site on the social networking system, or visiting a site on the file sharing system, and further comprising authenticating share group members who accept the invitations.

17. The method of claim 16, wherein the authenticating includes accepting user information corresponding to the social networking system.

18. The method of claim 17, wherein the authenticating further comprises transmitting an identification code, but not the user information, to the file sharing system.

19. A computer readable medium containing instructions for causing a computer to implement the method of claim 1.

20. A method for sharing files, comprising:
a. storing a file in a share folder on a user computer, or uploading a file to a file sharing server;
b. defining a share group within a social networking system; and
c. making the file accessible to the share group within the social networking system.
